(19) United States
(12) Patent Application Publication
(10) Pub. No.: US 2002/0082723 A1
(43) Pub. Date: Jun. 27, 2002

(54) Method and assembly for auditing the operation of a mechanical washing apparatus

(75) Inventors: Leonard Marcus Flendrig, Vlaardingen (NL); Jan Ophoff, Wageningen (NL); Hank Robert Reinhoudt, Vlaardingen (NL); Harm Jan Riksen, Vlaardingen (NL); Jan Hendrik Verbeek, Vlaardingen (NL); Alexandru Volanschi, Vlaardingen (NL)

Correspondence Address: UNILEVER, PATENT DEPARTMENT, 45 RIVER ROAD, EDGEWATER, NJ, 07020, US

(73) Assignee: Diversey Lever, Inc.

(21) Appl. No.: 10/013,792

(22) Filed: Dec. 11, 2001

(30) Foreign Application Priority Data
Dec. 13, 2000 (EP) 00204496.4

(51) Int. Cl. G05B 13/02

(52) U.S. Cl. 700/31

(57) ABSTRACT

The invention provides a method for auditing the operation of a mechanical washing apparatus, at least comprising the steps of

providing a generic model of the processes occurring inside of the mechanical washing apparatus;

during operation of the mechanical washing apparatus determining physical and/or mechanical parameters of the washing processes occuring inside of the mechanical washing apparatus; and

using the determined physical and/or mechanical parameters for transforming the generic model into a specific model of the processes occuring inside of the respective mechanical washing apparatus. Further the method may comprise the step of determining the performance (cleaning result) of the mechanical washing apparatus, for verifying the specific model or for use in transforming the generic model into the specific model. An assembly for carrying out the method is provided too.

### FIELD OF THE INVENTION

The invention firstly relates to a method for auditing the operation of a mechanical washing apparatus. With the expression “mechanical washing apparatus” each apparatus for washing objects is meant which performs typically at least a mechanical action (however without excluding any other, such as for example chemical, action). An example of such an apparatus may be a ware washing apparatus, however also apparatuses for washing other objects, such as for example laundry, dishes, bottles etcetera, are meant. Further the present invention is especially applicable to industrial apparatuses without however excluding apparatuses for domestic use.

The invention also relates to an assembly for auditing the operation of a mechanical washing machine.

### BACKGROUND OF THE INVENTION

The optimisation of the operation of mechanical washing apparatuses becomes more and more an important customer request. By such an optimisation not only the obtained cleaning performance of the apparatus may be optimised, but it also becomes possible to take into account other factors, such as an improved use of materials, a reduced energy consumption and a reduction of environmental pollution. It is evident that the possibility of optimising the operation of such an apparatus constitutes an increasingly important economical factor. It is an object of the present invention to provide a method for enabling such an optimisation.

Definition of the Invention

Thus according to the invention there is provided a method for auditing the operation of a mechanical washing apparatus, at least comprising the steps of

providing a generic model of the processes occurring inside of the mechanical washing apparatus;

during operation of the mechanical washing apparatus determining physical and/or mechanical parameters of the washing processes occuring inside of the mechanical washing apparatus; and

using the determined physical and/or mechanical parameters for transforming the generic model into a specific model of the processes occuring inside of the respective mechanical washing apparatus.

In an other aspect, the invention provides an assembly for auditing the operation of a mechanical washing apparatus, at least comprising

first means for providing a generic model of the processes occurring inside of the mechanical washing apparatus;

second means for, during operation of the mechanical washing apparatus, determining physical and/or mechanical parameters of the washing processes occuring inside of the mechanical washing apparatus; and

third means for transforming the generic model into a specific model of the processes occuring inside of the respective mechanical washing apparatus using the determined physical and/or mechanical parameters.

### DETAILED DESCRIPTION OF THE INVENTION

By means of the method according to the invention the basic tools are provided for optimising the operation of a mechanical washing apparatus. Firstly a generic model of the processes occurring inside of the mechanical washing apparatus has to be provided (it is noted that “firstly” should not strictly be understood in a time-sense). The provision of such a model may comprise the modelling itself or may be the inclusion of a standard generic model known per se. This generic model may, for example, be a mathematical computer model. Further the physical and/or mechanical parameters of the washing processes occuring inside of the mechanical washing apparatus have to be determined. This determination may occur by means of devices known per se or by means of devices to be developed specifically for this goal. It is noted, that herein the indication “physical” is to be understood as including biological and chemical too. Finally, using the determined physical and/or mechanical parameters the generic model is transformed into a specific model. This model then may be used to diagnose or analyse the operation of the apparatus in question and to apply the results for any optimisation required or desired.

One of the major advantages of the method according to the invention is the possibility of a non-invasive and fast on-site diagnosis and optionally alteration of the operation of a mechanical washing apparatus, wherein in an excellent manner the desires of the user of the apparatus can be taken into account.

In a preferred embodiment the method is characterized by the further step of determining the performance (cleaning result) of the mechanical washing apparatus. This determined performance basically may be used in two different ways. Firstly, the determined performance may be used in a further step of verifying the specific model. Thus, the correctness of the specific model may be verified by checking whether the performance predicted by the specific model under specific circumstances corresponds with the determined performance. It should be noted, that this verifying step may also include a further sophistication of the specific model, if needed, based upon the difference between predicted and determined performance.

Secondly it is possible that the determined performance is used in the step of transforming the generic model into the specific model, and thus already contributes to the determination of the specific model. Any verification of the specific model, if any, then has to take place on another basis.

Further the method according to the invention may be used in such a way that, using the specific model, on the basis of setting at least one of the parameters the remaining parameters of the washing processes are calculated. This gives the possibility of taking into account specific demands of a user of the apparatus. For example, in certain cases the most important factor is the cleaning performance, whereas in other cases the amount of materials (for example chemicals) is more important, whereas in still another case the cost of the washing process may be an important feature. The parameter(s) defining this most important factor(s) then is/are set, whereafter the specific model calculates the remaining parameters.

As a further development the specific model is used to find at least one optimum for at least one of the parameters governing the washing process and performance of the mechanical washing apparatus. The choice of such an optimum may be governed by different factors, such as needs or habits of a customer. It is noted that it might be possible that there is more than one optimum. The determination of a “general” optimum, i.e. an optimum in which the combination of all parameters is optimised, might require the introduction of weighing factors for the separate parameters in order to give a “ranking” of the importance of each parameter. In most instances, however, a “local” optimum for a limited set of parameters will be needed.

In another embodiment the step of determining physical and/or mechanical parameters is carried out by a monitoring device introduced into the mechanical washing apparatus. The physical and/or mechanical parameters to be determined may comprise, among others, residence time, chemicals amount and/or concentration, temperature, pressure and spray pattern of supplied washing liquor, type of soil and type of objects to be washed. Of course also other ways of determining at least some of these parameters are envisaged. For example, a questionnaire may be used to be completed by the user of the respective apparatus in respect of the type of soil and type of objects to be washed. However, also in these cases these parameters may be used to configure the specific model.

The step of determining the performance may be carried out by standardized soiled substrates introduced into the mechanical washing apparatus. For example, the standardized soiled substrates can be shaped substantially similarly to the objects to be washed in the mechanical washing apparatus, and thus represent the real objects in a correct manner whereas providing representative and reproduceable results. One example of such a standardized soiled substrate may be provided by a flexible strip which is positioned inside a soup cup. The surface of this strip has similar qualities as the surface of the soup cup and is soiled in a standardized manner. The obtained cleaning result of the strip then offers a proper indication of the performance of the washing apparatus. When the substrates are tile-shaped good results are obtained. The tile shape is simple, cheap but still versatile. For example, when the substrates comprise an array of planar elements arranged in the shape of a cup, the planar elements may comprise the said tile-shaped elements. The cup forms an imitation of a real cup, such as a soup cup. In this specific embodiment of the method according to the invention a dish washer will be audited.

The step of determining physical and/or mechanical parameters, and soil removal performance, may further comprise visually inspecting the mechanical washing apparatus. For example, visually inspecting the mechanical washing apparatus is carried out by video means introduced into the apparatus. The video means may record images or send these directly to a monitor. These images provide information about the internal configuration of the apparatus, such as spray nozzle location, orientation and functioning, as well as soil removal rate and mechanism obtainable with said apparatus. For providing the information on soil removal rate and mechanism, standardised soiled substrates, preferably transparent tiles, are used.

The use of the determined parameters (and optionally the determined performance) in configuring the specific model may occur in different ways. So it is possible that the determined parameters and performance are used on site for transforming the generic model into a specific model. In this embodiment the entire method is conducted on site. Therefore corresponding data processing means should be provided.

Alternatively, however, the determined parameters and performance are transferred to a centralized processing unit for transforming the generic model into a specific model. In this embodiment the collected data are transmitted to a centralized location distant from the apparatus itself. This opens the possibility of a remote-controlled auditing of the apparatus. Further, in this embodiment copying of the method by unauthorised third parties is not possible because the real processing occurs remotely.

In another useful embodiment, the generic model is located on an internet server that can be accessed from a customer site, when aiming to transform this generic model into a specific model which is adapted to the operation of the mechanical washing apparatus of the customer concerned.

When the method according to the invention is carried out in combination with a monitoring device introduced into the mechanical washing apparatus, and is meant for application with a mechanical washing apparatus having conveyor means for the objects (such as ware) to be washed, a preferred embodiment envisages that the monitoring device is positioned on the conveyor means to travel along therewith through the apparatus. As a first possibility the monitoring device then is positioned loose on the conveyor means and occasionally determines the said parameters. The monitoring device may record the parameters or may transmit these.

As a second possibility the monitoring device is fixed to the conveyor means and continuously determines the said parameters. This makes it possible to continuously monitor the apparatus and the process occurring therein. Especially in this embodiment it is of advantage when the monitoring device communicates wirelessly with a base station for accumulating data. This base station may comprise processing means as mentioned before.

It has been mentioned before, that a safeguard against unauthorised copying of the method according to the invention may be obtained by transferring the determined parameters and performance to a centralized processing unit. However, in certain applications it is preferred to use these parameters and performance on site, for example in a stand-alone version. In such a case it is possible that the steps of the method as mentioned are preceded by an authorisation step. On-site monitoring devices and/or processing means then only can be activated by the authorisation step, which of course is only available for authorised personnel.

For example, the authorisation step comprises entering an authorisation code, such as by means of a SIMM-card.

As mentioned above, the invention further relates to an assembly for auditing the operation of a mechanical washing apparatus, at least comprising

first means for providing a generic model of the processes occurring inside of the mechanical washing apparatus;

second means for, during operation of the mechanical washing apparatus, determining physical and/or mechanical parameters of the washing processes occuring inside of the mechanical washing apparatus; and

third means for transforming the generic model into a specific model of the processes occuring inside of the respective mechanical washing apparatus using the determined physical and/or mechanical parameters.

It is possible that the second means comprise a monitoring device introduced into the mechanical washing apparatus.

Further, the assembly preferably comprises fourth means for determining the performance (cleaning result) of the mechanical washing apparatus. In this aspect, the fourth means may comprise standardized soiled substrates introduced into the mechanical washing apparatus.

In yet another embodiment of the assembly according to the invention, the second means further comprise video means for visually inspecting the mechanical washing apparatus. Finally it is possible that the assembly comprises authorisation means.

The invention is not limited to the embodiments described before which can be varied widely within the scope of the invention as defined by the claims.

1. Method for auditing the operation of a mechanical washing apparatus, at least comprising the steps of
providing a generic model of the processes occurring inside of the mechanical washing apparatus;
during operation of the mechanical washing apparatus determining physical and/or mechanical parameters of the washing processes occuring inside of the mechanical washing apparatus; and
using the determined physical and/or mechanical parameters for transforming the generic model into a specific model of the processes occuring inside of the respective mechanical washing apparatus.

2. Method according to claim 1, characterized by the further step of determining the performance (cleaning result) of the mechanical washing apparatus.

3. Method according to claim 1, characterized in that the determined performance is used in a further step of verifying the specific model.

4. Method according to claim 1, characterized in that the determined performance is used in the step of transforming the generic model into the specific model.

5. Method according to claim 1, characterized in that, using the specific model, on the basis of setting at least one of the parameters the remaining parameters of the washing processes are determined.

6. Method according to claim 1, characterized in that the specific model is used to find at least one optimum for at least one of the parameters governing the washing process and performance of the mechanical washing apparatus.

7. Method according to claim 1, characterized in that the step of determining physical and/or mechanical parameters is carried out by a monitoring device introduced into the mechanical washing apparatus.

8. Method according to claim 1, characterized in that the step of determining the performance is carried out by standardized soiled substrates introduced into the mechanical washing apparatus.

9. Method according to claim 8, characterized in that the standardized soiled substrates are shaped substantially simularly to the objects to be washed in the mechanical washing apparatus.

10. Method according to claim 9, characterized in that the substrates are tile-shaped.

11. Method according to claim 9, characterized in that the substrates comprise an array of planar elements arranged in the shape of a cup.

12. Method according to claim 1, characterized in that the step of determining physical and/or mechanical parameters further comprises visually inspecting the mechanical washing apparatus.

13. Method according to claim 12, characterized in that visually inspecting the mechanical washing apparatus is carried out by video means introduced into the apparatus.

14. Method according to claim 1, characterized in that the physical and/or mechanical parameters to be determined may comprise, among others, residence time, chemicals amount and/or concentration, temperature, pressure and spray pattern of supplied washing liquor, type of soil and type of objects to be washed.

15. Method according to claim 1, characterized in that the determined parameters and performance are used on site for transforming the generic model into a specific model.

16. Method according to any of the claims 1-14, characterized in that the determined parameters and performance are transferred to a centralized processing unit for transforming the generic model into a specific model.

17. Method according to claim 1 and for application with a mechanical washing apparatus having conveyor means for the objects to be washed, characterized in that the monitoring device is positioned on the conveyor means to travel along therewith through the apparatus.

18. Method according to claim 17, characterized in that the monitoring device is positioned loose on the conveyor means and occasionally determines the said parameters.

19. Method according to claim 17, characterized in that the monitoring device is fixed to the conveyor means and continuously determines the said parameters.

20. Method according to claim 1, characterized in that the monitoring device communicates wirelessly with a base station for accumulating data.

21. Method according to any of the previous claims, characterized in that the steps mentioned are preceded by an authorisation step.

22. Method according to claim 21, characterized in that the authorisation step comprises entering an authorisation code.

23. Assembly for auditing the operation of a mechanical washing apparatus, at least comprising
first means for providing a generic model of the processes occurring inside of the mechanical washing apparatus;
second means for, during operation of the mechanical washing apparatus, determining physical and/or mechanical parameters of the washing processes occuring inside of the mechanical washing apparatus; and
third means for transforming the generic model into a specific model of the processes occuring inside of the respective mechanical washing apparatus using the determined physical and/or mechanical parameters.

24. Assembly according to claim 23, characterized in that the second means comprise a monitoring device introduced into the mechanical washing apparatus.

25. Assembly according to claim 23, characterized by fourth means for determining the performance (cleaning result) of the mechanical washing apparatus.

26. Assembly according to claim 25, characterized in that the fourth means comprise standardized soiled substrates introduced into the mechanical washing apparatus.

27. Assembly according to claim 23, characterized in that the second means further comprise video means for visually inspecting the mechanical washing apparatus.

28. Assembly according to claim 23, characterized by authorisation means.
